(19) United States
(12) Patent Application Publication
(10) Pub. No.: US 2006/0182602 A1
(43) Pub. Date: Aug. 17, 2006

(54) Parallel manipulator having backlash-free gearnings

(76) Inventors: Hans Andrea Schuler, Glarus (CH); Martino Filippi, Loehningen (CH); Samuel Schuler, Zurich (CH)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 10/517,531

(22) PCT Filed: Jun. 3, 2003
(86) PCT No.: PCT/CH03/00346

§ 371 Date: Dec. 12, 2005

(30) Foreign Application Priority Data
Jun. 13, 2002 (DE) 20209440.5

(51) Int. Cl. B25J 17/02

(52) U.S. Cl. 414/735

(57) ABSTRACT

A delta robot has motor/gearing units, which are respectively assigned to an arm and which are disposed on one side each of a triangle. Each motor/gearing unit has a gearing, by virtue of material-locking and/or positive-locking connection of gearing components, is free from backlash over the whole of the motional range of the gearing, allowing virtually all aspects fundamental to the delta robot to be optimized, especially the rigidity, the control characteristics, the spatial requirement, the speed and the positioning accuracy.

### TECHNICAL FIELD

The invention relates to a device for moving and positioning an object in space, according to the preamble of claim 1. The device in question is referred to amongst experts as a robot with parallel kinematics or a delta robot.

### PRIOR ART

A device of the generic type for moving and positioning an object in space is described in EP-A-0'250'470. This Delta robot has a base plate on which first ends of three arms are pivotably disposed. Each arm is individually driven by a motor, the three motors being disposed in such a manner in a plane defined by the base plate that one each of the motor shafts runs along one side each of an imaginary equilateral triangle. The second ends of the arms are hinge-connected to a common mounting plate. On this mounting plate there are disposed gripping means, for example a suction cup, for seizing and holding the object to be moved. A telescopic fourth shaft, which is driven by a fourth motor, is hinge-connected to the base plate and to the mounting plate.

A similar device is known from EP-A-1'129'829. Here the motors are disposed beneath the plane of the base plate. Furthermore, the fourth shaft passes through the base plate and is connected above the base plate to the fourth motor.

These delta robots have proved themselves in automated plants, especially in the packaging industry. They have the advantage of being able to move at high speed, and yet precisely, between two positions and of being able to reach positions within a relatively large three dimensional area.

Usually, the drive motors are coupled with the individual arms by means of a gearing. These motor/gearing units should allow high, reproducible positioning accuracy of the gripping means, even in rapid start/stop operations. The gearing should thus be virtually free from backlash, allow rapid acceleration and have the smallest possible volume.

From WO 00/35640 and EP-A-1'129'829, for instance, motor/gearing units are known which are used in these delta robots. In WO 00/35640 (FIG. 1), a high-build, two-step spur gearing is used; in EP-A-1'129'829 (FIG. 5), the structural height extends beyond the base plate. This is disadvantageous, since the natural frequency behavior of the suspension device in which the delta robot is mounted deteriorates roughly in squared proportion to any increase in structural height. At higher working speeds, the required accuracy is hence no longer achieved. In order to prevent this, the delta robot must have a larger mass, which, in turn, adversely affects the statics.

A further problem is the structural height of the suspension device itself, which, in case of correspondingly low headroom at the place of installation, prevents the use of the device or at least requires the delta robot to be lowered. Such a lowering of the work area is inadmissible if immediately preceding or succeeding works have to be carried out manually.

Likewise, DE-A-4'413'872 discloses a gearing with lowest possible backlash and without torsionally elastic tensions. This planetary gearing has gear steps which, in the assembly, allow radial displacement of the bearings of the planet carrier and of the two ring wheels. Although the gearing acts the same in both rotational directions, it does have negative vibration characteristics.

DE-A-197'57'433 delves more deeply into the problems of the known motor/gearing units for rapid positioning tasks. In addition to the fundamental problem of freedom from backlash, consideration must in fact be given to the inevitable wear on the gearing. DE'433 starts from the insight that for high positioning accuracy it is sufficient to minimize in the region of the end positions a backlash present in the planetary gearing. Backlash-conditioned positional changes occurring in intermediate positions are accepted. Measures are therefore proposed which have an impact solely in respect of minor torques which are to be transmitted through the gearing. These measures consist in the provision of an auxiliary gearwheel, which cooperates with the planet wheel and rotates coaxially and which has a smaller width than the planet wheel. The auxiliary gearwheel is tensioned in a torsionally elastic manner with a spring, the tension leading to the planet wheel, in the end positions, adopting a defined position. This freedom from backlash which is present only in the end positions, and the directional independence associated therewith, have an adverse effect, however, upon wear and quietness of running, the rigidity of the gearing and the vibration characteristics.

From GB-A-2'213'555, a backlash-free gearing for industrial robots is additionally known, in which the shock produced by a change in rotational direction is prevented by a split-direction torque transmission. This split-direction torque transmission is achieved by the axes of the planet wheels being arranged offset relative to the axis of the sun wheel. Thus, the teeth of the planet wheels mesh in one rotational direction on one flank of the ring wheel and in the opposite rotational direction on the opposite side.

DE-A-100'58'192 describes a backlash-free planetary gearing. The planet wheels, which mesh between sun wheel and ring wheel, are respectively mounted rotatably about a planet wheel bolt and are fixed by this to a planet carrier. These planet wheel bolts are fixedly connected to the planet carrier solely in a material-locking manner. Preferably, they are welded.

### REPRESENTATION OF THE INVENTION

The object of the invention is to provide a delta robot of the type stated in the introduction, which has an optimized drive unit in relation to backlash, size, vibration characteristics and control parameters.

This object is achieved by a device having the features of claim 1.

The delta robot according to the invention has a gearing, at least one gear step, or its components, of which is tensioned and the freedom from backlash of which is achieved by the fact that individual gearing components are connected to one another in a material-locking and/or positive-locking manner in order to enable the gearing to be free from backlash over the whole of the motional range.

The material-locking and/or positive-locking connection, in combination with the tension of the components of the gear steps, leads to increased rigidity in both motional directions and thereby allows a correspondingly optimized control, leading to a more rigid system behavior. The freedom from backlash which exists over the whole of the motional range optimizes, moreover, the vibration characteristics and accuracy of the delta robot. In a preferred embodiment, the rigidity is identical in both motional directions, so that the same control parameters can be applied for both directions. In a preferred embodiment, at least one gear step is tensioned in a rotationally symmetric manner.

If the motor is connected coaxially to the gearing unit, then the motor/gearing unit can be made very compact and thus relatively small. This reduces the total weight and the spatial requirement of the unit, especially in relation to the structural height, which, in turn, has a beneficial effect upon the vibration characteristics of the suspension device. Since, in delta robots, the units are disposed in one plane and on one side each of a polygon, especially of a triangle, the minimization of the size of the unit is of central importance.

A solely material-locking connection has the advantage, compared to a positive-locking and material-locking or a purely positive-locking connection, that the manufacture of the gearing is simplified, that lesser demands in terms of dimensional accuracy are placed upon the individual components and upon the assembly, and that the gearing can be made smaller and lighter.

Further advantageous embodiments derive from the dependent claims.

### BRIEF DESCRIPTION OF THE DRAWINGS

The subject of the invention is explained below with reference to a preferred illustrative embodiment represented in the appended drawings, in which:

FIG. 1 shows a perspective representation of a delta robot;

FIG. 2 shows a detail of the delta robot according to FIG. 1 with a motor/gearing unit according to the invention;

FIG. 3 shows a motor/gearing unit according to FIG. 2, and

FIG. 4 shows an exploded representation of the fastening of an arm to the motor/gearing unit.

### WAYS OF REALIZING THE INVENTION

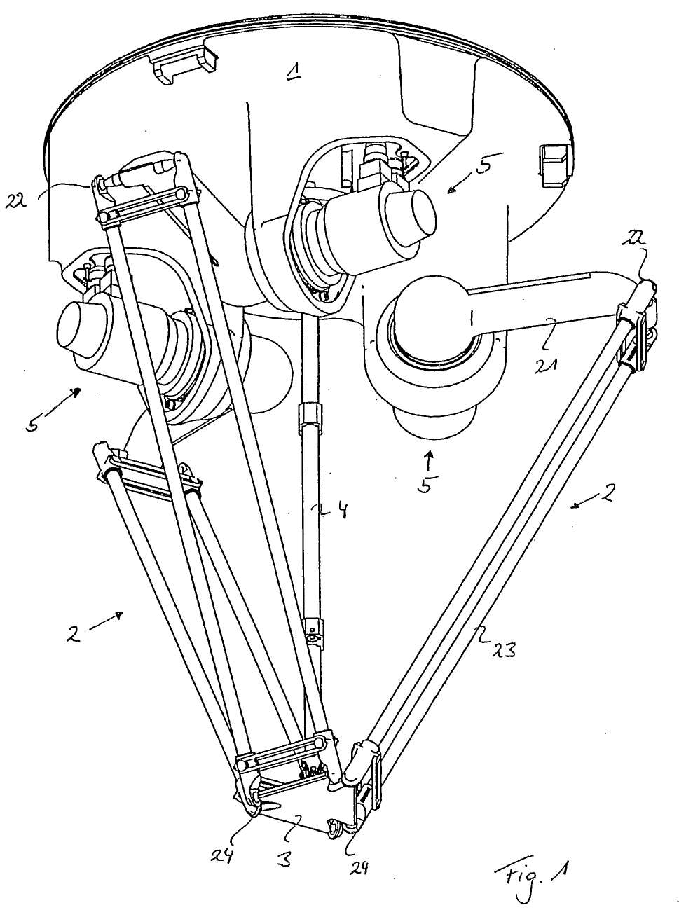

FIG. 1 represents a delta robot of the known type, such as is described, for example, in EP-A-0'250'470 and EP-A-1'129'829. Its structure and its control system will therefore no longer be discussed in detail. The delta robot, the motions of which are executed according to the principle of parallel kinematics, has essentially a base element 1, at least three arms 2, a carrier element 3 with gripping means (not represented), for example a suction cup, and a dedicated motor/gearing unit 5 for each arm. Preferably, a telescopic fourth shaft 4, disposed 25 centrically relative to the arrangement of the arms 2, is additionally present. Specific to the delta robot is that the arms 2 are disposed, via the associated motor/gearing unit 5, in an articulated manner on the base element 1, here of plate-shaped configuration, and, via a lower joint 24, on the common carrier element 3, here likewise of plate-shaped configuration, the associated motor/gearing units 5 being disposed in a common plane on the sides of an imaginary polygon. Preferably, there are three arms 2 present and the polygon is configured as an equilateral triangle.

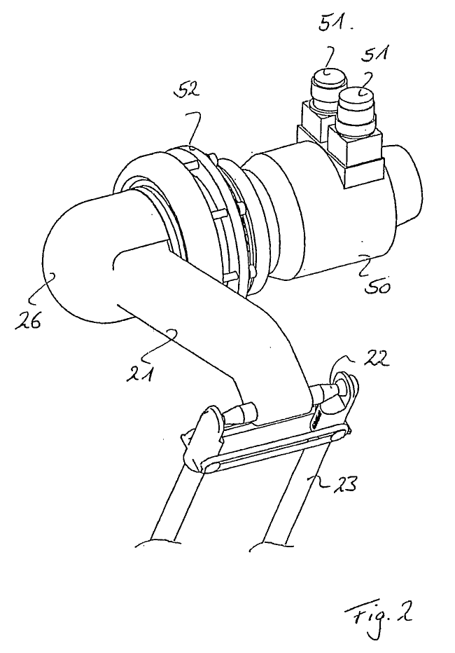

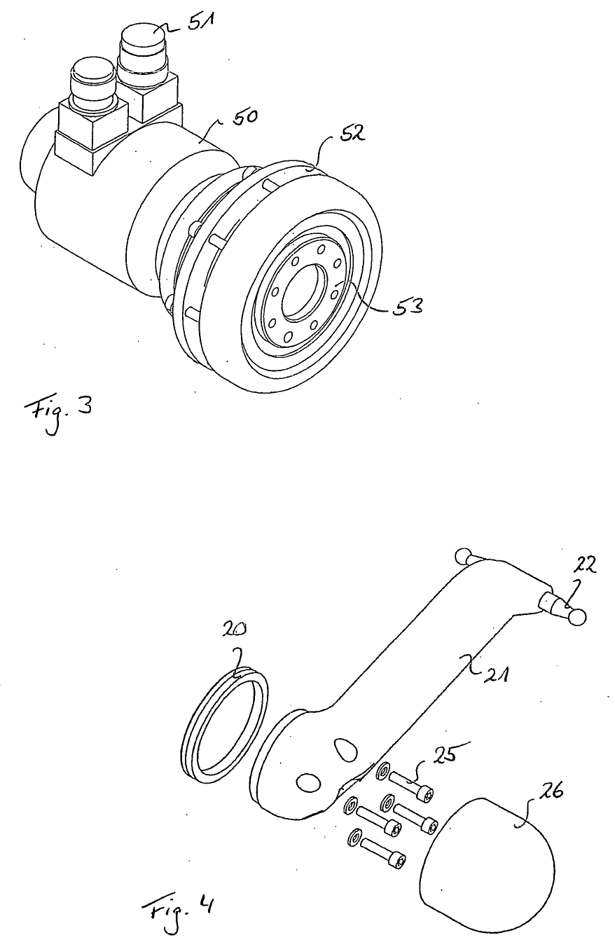

As can be seen in FIG. 2, each motor/gearing unit 5 has a motor 50 and a gearing 52. The motor 50 is connected by motor connections 51 to a control system (not represented). The motor can be a servo motor, an asynchronous motor, a three-phase motor or another motor suitable for the field of application. As represented in FIG. 2, the motor 50 is connected coaxially to the gearing in order to obtain a compact construction. The common axis herein lies on one side of the abovementioned imaginary polygon. The associated arm 2 is fixedly connected to the gearing 52 by a gearing-side connecting flange 53, which is visible in FIG. 3. The arm 2 therefore comprises an upper arm 21, fixedly connected to the gearing 52, and a lower arm 23, hinge-connected to said upper arm by an upper joint 22, for example a universal joint.

The upper arm 21, as can be seen in FIG. 4, is screwed via an arm-side connecting flange 20 to the gearing-side connecting flange 53. The fastening screws 25 are preferably covered over with a cover cap 26 in order to prevent dirtying and facilitate cleaning.

The gearing 52 which is used in this arrangement has gear steps which, during the assembly, can be adjusted relative to one another to compensate for production-conditioned gear tolerances. Preferably, the gear steps are tensioned in a rotationally symmetric manner. Furthermore, the configuration is virtually free from backlash over the whole of the motional range, since individual gearing components are connected in a positive-locking and/or material-locking manner. Preferably, at least one of these gear steps has coaxially running rotation axes on the drive side and the power-take-off side, the motor 50 likewise running coaxially relative to this axis. The gearing 52 can be of single-step or multi-step configuration. Preferably, it is a planetary gearing. Embodiments having combined spur and planetary gearings, or other hybrid multi-step gearings, are also possible. In the case of the combined spur and planetary gearing, at least one gear step is present, the drive-side rotation axis of which runs axially offset relative to its rotation axis on the power-take off side.

In a preferred embodiment, the gearing is a planetary 5 gearing, as described in DE-A-100'58'192 and marketed by the company Wittenstein under model designation TPM 025. This gearing has means for permanent backlash compensation for desired backlash free running.

In another embodiment it is a planetary gearing, as described in GB-A-2'213'555. The gearing is configured as a so-called harmonic drive gearing, that is to say with an elliptical disk with centric hub and elliptically deformable ball bearings, an elliptically deformable bushing with external toothing and a rigid cylindrical ring with internal toothing.

The device according to the invention allows virtually all aspects fundamental to the delta robot to be optimized, in particular increased rigidity, more direct control characteristics, lower spatial requirement, higher speed and improved positioning accuracy.

### REFERENCE SYMBOLS LIST

1 base element
2 arm
20 arm-side connecting flange
21 upper arm
22 upper joint
23 lower arm
24 lower joint
25 fastening screws
26 cover cap
3 carrier element
4 fourth shaft
5 motor/gearing unit
50 motor
51 motor connections
52 gearing
53 gearing-side connecting flange

1-10. (canceled)

11. A device for moving and positioning an object in space, the device comprising
a base element (1),
at least three motor/gearing units (5) disposed on the base element (1),
a common supporting element (3) on which at least one gripping means for gripping of an object is disposed,
at least three arms (2) each having a first end connected to a motor/gearing unit (5) and a second end hinge-connected to the common supporting element (3),
the motor/gearing units (5) being disposed in such a manner in a plane defined by the base element (1) or in a plane running parallel thereto that they form the sides of an imaginary polygon,
the motor/gearing unit (5) having a gearing (52), at least one gear step of which is tensioned, and
the gearing (52), by virtue of material-locking and/or positive-locking connection of gearing components, being free or virtually free from backlash over the whole of the motional range of the gearing (52).

12. The device as claimed in claim 11, wherein precisely three arms (2) and precisely three motor/gearing units (5) are present, and wherein one each of the motor/gearing units (5) is disposed on one side each of an imaginary triangle.

13. The device as claimed in claim 12, wherein the imaginary triangle is equilateral.

14. The device as claimed in claim 11, further comprising a telescopic fourth shaft (4) connected to the carrier element (3).

15. The device as claimed in claim 12, further comprising a telescopic fourth shaft (4) connected to the carrier element (3).

16. The device as claimed in claim 13, further comprising a telescopic fourth shaft (4) connected to the carrier element (3).

17. The device as claimed in claim 11, wherein the motor/gearing unit (5) comprises at least one gear step, at least one of these gear steps, preferably all, having coaxially running rotation axes on the drive side and the power-take-off side, and a motor (50) which is coaxially connected to this at least one gear step.

18. The device as claimed in claim 12, wherein the motor/gearing unit (5) comprises at least one gear step, at least one of these gear steps, preferably all, having coaxially running rotation axes on the drive side and the power-take-off side, and a motor (50) which is coaxially connected to this at least one gear step.

19. The device as claimed in claim 11, wherein the gearing (52) is a planetary gearing, and wherein the planetary gearing has planet wheels which mesh between a sun wheel and a ring wheel, are respectively fixed by a planet wheel bolt to a planet carrier and are mounted rotatably about the respective planet wheel bolt.

20. The device as claimed in claim 17, wherein the gearing (52) is a planetary gearing, and wherein the planetary gearing has planet wheels which mesh between a sun wheel and a ring wheel, are respectively fixed by a planet wheel bolt to a planet carrier and are mounted rotatably about the respective planet wheel bolt.

21. The device as claimed in claim 11, wherein the gearing (52) is a planetary gearing, and wherein the planetary gearing has planet wheels which mesh between a sun wheel and a ring wheel, the axes of the planet wheels being arranged offset in comparison to the axis of the sun wheel.

22. The device as claimed in claim 12, wherein the gearing (52) is a planetary gearing, and wherein the planetary gearing has planet wheels which mesh between a sun wheel and a ring wheel, the axes of the planet wheels being arranged offset in comparison to the axis of the sun wheel.

23. The device as claimed in claim 17, wherein the gearing (52) is a planetary gearing, and wherein the planetary gearing has planet wheels which mesh between a sun wheel and a ring wheel, the axes of the planet wheels being arranged offset in comparison to the axis of the sun wheel.

24. The device as claimed in claim 11, wherein the gearing (52) is of single-step or multi-step configuration.

25. The device as claimed in claim 17, wherein the gearing (52) is of single-step or multi-step configuration.

26. The device as claimed in claim 19, wherein the gearing (52) is of single-step or multi-step configuration.

27. The device as claimed in claim 11, wherein the gearing (52) is a combined spur-planetary gearing, at least one gear step being present, the drive-side axis of which runs axially offset relative to its axis on the power-take-off side.

28. The device as claimed in claim 11, wherein the at least one tensioned gear step is tensioned in a rotationally symmetric manner.

29. The device as claimed in claim 17, wherein the at least one tensioned gear step is tensioned in a rotationally symmetric manner.

30. The device as claimed in claim 19, wherein the at least one tensioned gear step is tensioned in a rotationally symmetric manner.
